(19) United States
(12) Patent Application Publication
(10) Pub. No.: US 2018/0346724 A1
(43) Pub. Date: Dec. 6, 2018

(54) TALL OIL PITCH BASED BINDERS, METHODS OF PRODUCING THE SAME, AND USES THEREOF

(71) Applicant: Ingevity South Carolina, LLC, North Charleston, SC (US)

(72) Inventors: Russell N. Fitzgerald, Mount Pleasant, SC (US); Brett A. Neumann, Mount Pleasant, SC (US)

(21) Appl. No.: 16/001,833

(22) Filed: Jun. 6, 2018

Related U.S. Application Data
(60) Provisional application No. 62/515,726, filed on Jun. 6, 2017.

(51) Int. Cl. C08L 93/04; C08L 91/00; F41J 9/16

(52) U.S. Cl. CPC C08L 93/04; F41J 9/16; C08L 91/00

(57) ABSTRACT

A bio-based or biodegradable binder is provided that may be made by: (a) mixing tall oil pitch with (i) rosin or fatty acid material, (ii) rosin and a fatty acid material, (iii) a tall oil bio fraction and rosin or fatty acid material, or (iv) rosin, fatty acid material, and tall oil bio fraction, wherein pitch, rosin, fatty acid material, and/or tall oil bio fraction is a salt thereof; or (b) mixing at least one of acrylic acid, maleic acid, maleic anhydride, fumaric acid, acrylic acid, methacrylic acid, or a combination thereof, to a mixture of: (i) tall oil pitch, and rosin or fatty acid material; (ii) rosin, tall oil pitch, and fatty acid material; (iii) tall oil pitch, tall oil bio fraction, and rosin or fatty acid material; or (iv) rosin, tall oil pitch, fatty acid material, and tall oil bio fraction.

### CROSS-REFERENCE TO RELATED APPLICATIONS

The present disclosure claims priority to U.S. Provisional Patent Application No. 62/515,726, filed 6 Jun. 2018, which is incorporated by reference in its entirety for all purposes.

### BACKGROUND

### 1. Field of the Art

The present disclosure relates to a bio-based composition that is biodegradable and environmentally friendly, method of producing the same; and articles including the same, e.g. a propellable target, having the bio-based composition as a binder, and methods of producing the same.

### 2. Description of Related Art

Clay target shooting (or clay pigeon shooting or Inanimate Bird Shooting) includes at least 20 different disciplines (e.g., sporting clays, trap shooting, skeet shooting, down-the-line trap shooting, Olympic trap, etc.) that include shooting a firearm at moving targets, such as clay pigeons or clay targets.

The shape and size of the clay targets depend upon the particular discipline that the marksman is engaged in. For example, standard clay targets are utilized in Trap, Skeet, and Sporting Clays have a 108 mm diameter and 28-29 mm height (about 100 g) in the United States competitions and have a 110 mm diameter and 25-26 mm height (about 105 g) in International competitions. Other clay targets can have, e.g., a 60 mm diameter and 20 mm height for the mini clay target (or the flying bumblebee) or have similar heights as a standard clay target but with a 90 mm diameter for the midi clay target. As such, clay pigeons are made to meet numerous different size specification and coloring (e.g., white, black, orange, yellow, etc.) depending upon the clay target shooting discipline it is utilized in.

The various clay target shooting disciplines propel the formed targets via a trap. Traps are devices designed to propel the different types of clay targets (either individually or in multiples) up to 100 meters. The way in which they are propelled depends upon the particular clay target discipline. For example, a rabbit clay target is a target that is thicker than the standard target and with a diameter of 108-110 mm so that it runs along the ground when propelled, while standard clay targets are propelled into the air from one (trap shooting) or more locations (skeet shooting). Thus, targets must have sufficient strength to retain structural integrity when propelled (i.e., to withstand the force applied to propel the clay target as well as to sustain the forces exerted against the clay target while in motion) and be designed to shatter into fragments when shot by a marksman.

The clay targets are generally prepared from inorganic particulate filler that is bound together via a petroleum based binder, such as coal tar or petroleum pitch. The petroleum-based binder is non-biodegradable and thus, is not environmentally friendly (i.e., it is harmful for/to the environment). Therefore, a need exists for a bio-based or biodegradable binder for use in the manufacture of propellable targets and propellable targets including the same, as well as other applications that result in the exposure of the adhesive to the environment.

### SUMMARY

The present disclosure relates to the surprising and unexpected discovery that a bio-based or biodegradable composition or binder could be produced using tall oil pitch and rosin or fatty acid material that is well suited for use in construction adhesives (e.g., roofing construction adhesive), as a binder to form composite articles, e.g., shooting targets (e.g., propellable shooting targets), mastics, etc. As such, the bio-based binder of the present disclosure are therefore particularly effective for use in shooting targets that need to withstand the forces exerted when propelled and will fragment when shot by a marksman. One skilled in the art will appreciate that the bio-based or biodegradable binder of the present disclosure is suitable for many other applications in which a binder is required, and in particular to applications that result in the exposure of the adhesive to the environment.

Therefore, in an aspect, the present disclosure provides a bio-based binder comprising tall oil pitch and at least one of rosin, a fatty acid material, or a combination thereof, wherein at least one of the tall oil pitch, the rosin, the fatty acid material, or a combination thereof is a salt thereof.

In some embodiments, wherein at least one of: the tall oil pitch is an alpha, beta-unsaturated carboxylic acid adducted/modified tall oil pitch; the rosin is an alpha, beta-unsaturated carboxylic acid adducted/modified rosin; the fatty acid material is an alpha, beta-unsaturated carboxylic acid adducted/modified fatty acid material; or a combination thereof.

In certain embodiments, the fatty acid material is a tall oil fatty acid.

In further embodiments, the bio-based binder further comprises a tall oil bio fraction.

In particular embodiments, the tall oil bio fraction is distilled tall oil or the heads fraction of crude tall oil distillation.

In other embodiments, the alpha, beta-unsaturated carboxylic acid adducted/modified pitch, the alpha, beta-unsaturated carboxylic acid adducted/modified rosin, and/or the alpha, beta-unsaturated carboxylic acid adducted/modified fatty acid material is produced by mixing at least one alpha, beta-unsaturated carboxylic acid selected from the group consisting of acrylic acid, maleic acid, maleic anhydride, fumaric acid, methacrylic acid, or a combination thereof, to a molten rosin, the pitch, or the fatty acid material.

In yet other embodiments, the alpha, beta-unsaturated carboxylic acid adducted/modified pitch, the alpha, beta-unsaturated carboxylic acid adducted/modified rosin, and/or the alpha, beta-unsaturated carboxylic acid adducted/modified fatty acid material is produced by mixing at least one alpha, beta-unsaturated carboxylic acid selected from the group consisting of acrylic acid, maleic acid, maleic anhydride, fumaric acid, methacrylic acid, or a combination thereof, to a mixture of: (i) the tall oil pitch, and the rosin or the fatty acid material; (ii) the rosin, the tall oil pitch, and the fatty acid material; (iii) the tall oil pitch, a tall oil bio fraction, and the rosin or the fatty acid material; or (iv) the rosin, the tall oil pitch, the fatty acid material, and a tall oil bio fraction.

In yet other embodiments, at least one of: the tall oil pitch or the alpha, beta-carboxylic acid adducted/modified tall oil pitch is a salt thereof; the rosin or the alpha, beta-carboxylic acid adducted/modified rosin is a salt thereof; the fatty acid material or the alpha, beta-carboxylic adducted/modified fatty acid material is a salt thereof; the tall oil bio fraction or an alpha, beta-carboxylic adducted/modified tall oil bio fraction is a salt thereof; or a combination thereof.

In certain embodiments, the tall oil pitch, the alpha, beta-unsaturated carboxylic acid adducted/modified pitch, or a salt thereof, is present in an amount of about 10 wt. % to about 70 wt. % of the bio-based binder.

In particular embodiments, the rosin, the alpha, beta-unsaturated carboxylic acid adducted/modified rosin, or a salt thereof, is present in an amount of about 30 wt. % to about 90 wt. % of the bio-based binder.

In yet further embodiments, the fatty acid material, the alpha, beta-unsaturated carboxylic acid adducted/modified fatty acid material, or a salt thereof, is present in an amount of about ≤70 wt. % (e.g., about 15 wt. % to about 35 wt. %) of the bio-based binder.

In another embodiment, the tall oil bio fraction, the alpha, beta-unsaturated carboxylic acid adducted/modified tall oil bio fraction, or a salt thereof, is present in an amount of about ≤90 wt. % (e.g., about 30 wt. % to about 60 wt. %) of the bio-based binder.

In some embodiments, at least one of: (1) the tall oil pitch salt or the alpha, beta-carboxylic adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (2) the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (3) the fatty acid material salt or the alpha, beta-carboxylic adducted/modified fatty acid material salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (4) the tall oil bio fraction salt or the alpha, beta-carboxylic adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; or (5) a combination thereof.

In certain other embodiments, at least one of the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, the tall oil bio fraction salt or the alpha, beta-carboxylic adducted/modified tall oil bio fraction salt, or a combination thereof, is a sodium salt.

In any aspect or embodiment described herein, the bio-based binder has at least one of the following: a softening point in a range of about 75° C. to about 140° C. (e.g., about 100° C. to about 120° C.); a viscosity of less than about 30,000 cP (e.g., about 5,000 to about 15,000 cP) at about 149° C. (about 300° F.); or a combination thereof.

In another aspect, the present disclosure provides an article formed from a composition including a particulate filler and the bio-based or biodegradable binder of the present disclosure. In certain embodiments, the article is a propellable target formed from a composition comprised of particulate filler and the bio-based or biodegradable binder of the present disclosure.

In some embodiments, at least one the following: the particulate filler is present in an amount of about 50 wt. % to about 95 wt. % of the article, e.g. a propellable target; the bio-based binder is present in an amount no greater than 50 wt. % of the article, e.g. a propellable target; or a combination thereof.

In certain embodiments, the particulate filler is an inorganic filler.

In particular embodiments, the inorganic filler is at least one of clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, or a combination thereof.

In other embodiments, the inorganic filler is at least one of clay, synthetic clay, calcium carbonate, magnesium carbonate, calcium hydroxide, calcium aluminate, magnesium carbonate, limestone, or a combination thereof.

In a further aspect, the present disclosure provides a method of making a bio-based binder. The method comprises either: (a) mixing tall oil pitch with (i) rosin or fatty acid material, (ii) the rosin and a fatty acid material, (iii) the rosin or the fatty acid material, and a tall oil bio fraction, or (iv) the rosin, the fatty acid material, and the tall oil bio fraction, wherein at least one of the pitch, the rosin, the fatty acid material, the tall oil bio fraction, or a combination thereof is a salt thereof; or (b) mixing at least one alpha, beta-unsaturated carboxylic acid selected from the group consisting of acrylic acid, maleic acid, maleic anhydride, fumaric acid, acrylic acid, methacrylic acid, or a combination thereof, to a mixture of: (i) the tall oil pitch and the rosin or the fatty acid material; (ii) the rosin, the tall oil pitch, and the fatty acid material; (iii) the tall oil pitch, the tall oil bio fraction, and the rosin or the fatty acid material; or (iv) the rosin, the tall oil pitch, the fatty acid material, and the tall oil bio fraction bio fraction; or (iv) the rosin, the tall oil pitch, the fatty acid material, and the tall oil bio fraction.

In any aspect or embodiment described herein, at least one of the pitch, the rosin, the fatty acid material, and the tall oil bio fraction of (a) is an alpha, beta-unsaturated carboxylic acid adducted/modified pitch, an alpha, beta-unsaturated carboxylic acid adducted/modified rosin, an alpha, beta-unsaturated carboxylic acid adducted/modified fatty acid material, an alpha, beta-unsaturated carboxylic acid adducted/modified tall oil bio fraction, or a combination therefore produced by mixing at least one alpha, beta-unsaturated carboxylic acid selected from the group consisting of acrylic acid, maleic acid, maleic anhydride, fumaric acid, acrylic acid, methacrylic acid, or a combination thereof, to a molten rosin, the pitch, the fatty acid material, the tall oil bio fraction, or a salt thereof.

In some embodiments, at least one of the following: (1) the tall oil pitch or the alpha, beta-unsaturated carboxylic acid adducted/modified tall oil pitch is present in an amount of about 10 wt %. to about 70 wt. % of the bio-based binder; (2) the rosin or the alpha, beta-unsaturated carboxylic acid adducted/modified rosin is present in an amount of about 30 wt. % to about 90 wt. % of the bio-based binder; (3) the fatty acid material or the alpha, beta-unsaturated carboxylic acid adducted/modified fatty acid material is present in an amount of about ≤70 wt. % of the bio-based binder; (4) the tall oil bio fraction or the alpha, beta-unsaturated carboxylic acid adducted/modified tall oil bio fraction is present in an amount of about ≤90 wt. % of the bio-based binder; or (5) a combination thereof.

In other embodiments, at least one of the following: the tall oil pitch or the alpha, beta-carboxylic acid adducted/modified tall oil pitch is a salt thereof; the rosin or the alpha, beta-carboxylic acid adducted/modified rosin is a salt thereof; the fatty acid material or the alpha, beta-carboxylic adducted/modified fatty acid material is a salt thereof; the tall oil bio fraction or an alpha, beta-carboxylic adducted/modified tall oil bio fraction is a salt thereof; or a combination thereof.

In certain embodiments, at least one of: (1) the tall oil pitch salt or the alpha, beta-carboxylic acid adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (2) the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (3) the fatty acid material salt or the alpha, beta-carboxylic acid adducted/modified fatty acid material salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (4) the tall oil bio fraction salt or the alpha, beta-carboxylic acid adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; or (5) a combination thereof.

In particular embodiments, at least one of the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, the tall oil bio fraction salt or the alpha, beta-carboxylic adducted/modified tall oil bio fraction salt, or a combination thereof, is a sodium salt.

In further embodiments, the bio-based binder has at least one of the following: a softening point in a range of about 75° C. to about 140° C. (e.g., about 100° C. to about 120° C.); a viscosity of less than 30,000 cP at about 149° C.; or a combination thereof.

In yet a further aspect, the present disclosure provides a method of making an article, e.g. a propellable target. The method comprises: mixing the bio-based composition of the present disclosure or produced according to the methods of the present disclosure and a particulate filler; and forming the mixture into a shape.

In some embodiments, at least one of the following: the particulate filler is present in an amount of about 50 wt. % to about 95 wt. % of the propellable target; the bio-based binder is present in an amount no greater than 50 wt. % of the propellable target; or a combination thereof.

In other embodiments, the particulate filler is an inorganic filler.

In certain embodiments, the inorganic filler is at least one of clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, or a combination thereof.

In certain other embodiments, the inorganic filler is at least one of clay, synthetic clay, calcium carbonate, magnesium carbonate, calcium hydroxide, calcium aluminate, magnesium carbonate, limestone, or a combination thereof.

In any aspect or embodiment described herein, forming the mixture into a shape comprises applying the mixture to a mold or extruding the mixture.

Further aspects, features, and advantages of the present invention will be apparent to those of ordinary skill in the art upon reading the following Detailed Description of the Preferred Embodiments.

### DETAILED DESCRIPTION

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. All publications, patent applications, patents, figures and other references mentioned herein are expressly incorporated by reference in their entirety.

The present disclosure provides a biodegradable or bio-based composition comprising tall oil pitch and rosin or a fatty acid material, wherein at least one of the tall oil pitch, the rosin, or the fatty acid material is a salt thereof, with the surprising and unexpected ability to be used as an environmentally favorable binder. In certain embodiment, as least one of the tall oil pitch, the fatty acid material, the rosin, or a combination thereof is an α,β-unsaturated carboxylic acid adducted or modified tall oil pitch, an α,β-unsaturated carboxylic acid adducted or modified fatty acid material, or an α,β-unsaturated carboxylic acid adducted or modified rosin. In addition, the present disclosure provides a method of producing the inventive biodegradable or bio-based composition or binder. Further, the present disclosure provides an article, such as a shooting target (e.g., a propellable shooting target), that comprises: particulate filler bound together by the biodegradable composition of the present disclosure, as well as methods of making the same.

The bio-based composition of the present disclosure can be utilized to make marksman targets that meet the structural requirements of propelled targets (i.e., maintains the target's structural integrity when propelled and while in motion, but fragments upon being shot by a marksman), while being biodegradable and therefore, environmentally friendly. The bio-based composition of the present disclosure degrades much more readily than petroleum based counterparts when exposed to environmental conditions such as water and sunlight, and may be utilized in any application in which an environmentally friendly binder would be preferable, such as outdoor binder applications including, e.g., construction adhesive, construction roofing adhesive, mastics, flooring adhesive (e.g. wood floor adhesive or tile adhesive), etc.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

The term “compound”, as used herein, unless otherwise indicated, refers to any specific chemical compound disclosed herein and includes tautomers, regioisomers, geometric isomers, and where applicable, stereoisomers, including optical isomers (enantiomers) and other stereoisomers (diastereomers) thereof. It is noted that in describing the present compounds, numerous substituents and variables associated with same, among others, are described. It is understood by those of ordinary skill that molecules which are described herein are stable compounds as generally described hereunder.

The Kraft process is the dominant method for producing wood pulp and tall oil is a by-product of this wood pulping process. After the digestion of wood chips, the wood pulp is sent for papermaking; the by-product, black liquor, is the source for crude tall oil (CTO). At the refineries, CTO is separated by distillation to produce heads, tall oil fatty acids (TOFA), distillated tall oil (DTO), tall oil rosin (TOR), and tall oil pitch (TOP). The most commonly used portions of the separation are TOFA and TOR, applied in fields such as adhesive, ink, rubber, paper sizing, metal working fluid, asphalt, oilfield chemical and as surfactants. Tall oil pitch contains the lower boiling alcohol, ethers, and palmitic acids of crude tall oil.

The term “bio-based”, as used herein, unless otherwise indicated, refers to a material that is completely or substantially made from substances derived from living or once-living organisms (e.g., plants, animals, marine materials, forestry materials, etc.).

The term “rosin” or “rosin acids” refers to mixtures of several related carboxylic acids such as abietic acid, neoabietic acid, dehydroabietic acid, palustric acid, levopimaric acid, pimaric acid and isopimaric acids found in tree resins. Nearly all resin acids have the same basic skeleton: three fused ring fused with the empirical formula C₁₉H₂₉COOH.

The terms “alpha, beta-unsaturated carboxylic acid adducted tall oil pitch”, “alpha, beta-unsaturated carboxylic acid modified tall oil pitch”, or “alpha, beta-unsaturated carboxylic acid adducted/modified tall oil pitch”, refers to tall oil pitch that has been reacted with an alpha, beta carboxylic acid, such as acrylic acid, maleic acid, maleic anhydride, fumaric acid, and/or methacrylic acid.

The terms “alpha, beta-unsaturated carboxylic acid adducted rosin”, “alpha, beta-unsaturated carboxylic acid modified rosin”, or “alpha, beta-unsaturated carboxylic acid adducted/modified rosin”, refers to rosin acids that has been reacted with an alpha, beta carboxylic acid, such as acrylic acid, maleic acid, maleic anhydride, fumaric acid, and/or methacrylic acid.

The terms “alpha, beta-unsaturated carboxylic acid adducted fatty acid material”, “alpha, beta-unsaturated carboxylic acid modified fatty acid material”, or “alpha, beta-unsaturated carboxylic acid adducted/modified fatty acid material”, refers to fatty acid material, as described herein, that has been reacted with an alpha, beta carboxylic acid, such as acrylic acid, maleic acid, maleic anhydride, fumaric acid, and/or methacrylic acid.

The terms “alpha, beta-unsaturated carboxylic acid adducted tall oil bio fraction”, “alpha, beta-unsaturated carboxylic acid modified tall oil bio fraction”, or “alpha, beta-unsaturated carboxylic acid adducted/modified tall oil bio fraction”, refers to tall oil bio fraction, as described herein, that has been reacted with an alpha, beta carboxylic acid, such as acrylic acid, maleic acid, maleic anhydride, fumaric acid, and/or methacrylic acid.

As used herein, “adduct” refers to a direct addition of two or more distinct molecules, resulting in a single reaction product containing all atoms of each of the distinct molecules.

The term “tall oil bio fraction”, as used herein, includes crude tall oil and any fraction obtained from crude tall oil processing and/or distillation. For example, a tall oil bio fraction can include, but is not limited to, crude tall oil, tall oil fatty acids, distilled tall oil, heads, rosin, etc.

In an aspect, there is provided a bio-based or biodegradable composition comprising tall oil pitch (e.g., Ingevity® Tallex Pitch) and at least one of rosin (e.g., Ingevity® Altapyne Rosin SS-A or Ingevity® Altapyne Rosin S), a fatty acid material (e.g., tall oil fatty acid), or a combination thereof, wherein at least one of the tall oil pitch, the rosin, the fatty acid material, or a combination thereof is a salt thereof. The bio-based composition may be used as a binder.

In any aspect or embodiment described herein, at least one of: the tall oil pitch is an alpha, beta-unsaturated carboxylic acid adducted/modified tall oil pitch; the rosin is an alpha, beta-unsaturated carboxylic acid adducted/modified rosin; the fatty acid material is an alpha, beta-unsaturated carboxylic acid adducted/modified fatty acid material; or a combination thereof. The alpha, beta-unsaturated carboxylic acid adducted/modified pitch, the alpha, beta-unsaturated carboxylic acid adducted/modified rosin, and/or the alpha, beta-unsaturated carboxylic acid adducted/modified fatty acid material is produced by mixing at least one alpha, beta-unsaturated carboxylic acid selected from the group consisting of acrylic acid, maleic acid, maleic anhydride, fumaric acid, methacrylic acid, or a combination thereof, to a molten rosin, the pitch, or the fatty acid material. The alpha, beta-unsaturated carboxylic acid adducted/modified pitch, the alpha, beta-unsaturated carboxylic acid adducted/modified rosin, and/or the alpha, beta-unsaturated carboxylic acid adducted/modified fatty acid material is produced by mixing at least one alpha, beta-unsaturated carboxylic acid selected from the group consisting of acrylic acid, maleic acid, maleic anhydride, fumaric acid, methacrylic acid, or a combination thereof, to a mixture of: (i) the tall oil pitch, and the rosin or the fatty acid material; (ii) the rosin, the tall oil pitch, and the fatty acid material; (iii) the tall oil pitch, a tall oil bio fraction, and the rosin or the fatty acid material; or (iv) the rosin, the tall oil pitch, the fatty acid material, and a tall oil bio fraction.

The α,β-unsaturated carboxylic acid and the rosin, the pitch, the fatty acid material, or the tall oil bio fraction may be combined or added or mixed in a ratio of carboxylic acid to pitch, rosin, fatty acid material, or tall oil bio fraction of about 1:1 to about 1:30 (e.g., about 1:15 to about 1:30 or about 1:24). For example, the ratio of carboxylic acid to pitch/rosin/fatty acid material/tall oil bio fraction is about 1:1 to about 1:30, about 1:5 to about 1:30, about 1:10 to about 1:30, about 1:15 to about 1:30, about 1:20 to about 1:30, about 1:25 to about 1:30, about 1:5 to about 1:25, about 1:10 to about 1:25, about 1:15 to about 1:25, about 1:20 to about 1:25, about 1:5 to about 1:20, about 1:10 to about 1:20, about 1:15 to about 1:20, about 1:5 to about 1:15, about 1:10 to about 1:15, or about 1:5 to about 1:10.

The rosin (e.g., Ingevity® Altapyne Rosin SS-A or Ingevity® Altapyne Rosin S) or the α,β-unsaturated carboxylic acid adducted/modified rosin or salt thereof (e.g., an α,β-unsaturated carboxylic acid adducted/modified Ingevity® Altapyne Rosin SS-A or Ingevity® Altapyne Rosin S) may be present in an amount of about 30 wt. % to about 90 wt. % of the bio-based binder. For example, the rosin or the α,β-unsaturated carboxylic adducted/modified rosin (or salt thereof) may be about 30 wt. % to about 80 wt. %, about 30 wt. % to about 70 wt. %, about 30 wt. % to about 60 wt. %, about 30 wt. % to about 50 wt. %, about 30 wt. % to about 40 wt. %, about 40 wt. % to about 90 wt. %, about 40 wt. % to about 80 wt. %, about 40 wt. % to about 70 wt. %, about 40 wt. % to about 60 wt. %, about 40 wt. % to about 50 wt. %, about 50 wt. % to about 90 wt. %, about 50 wt. % to about 80 wt. %, about 50 wt. % to about 70 wt. %, about 50 wt. % to about 60 wt. %, about 60 wt. % to about 90 wt. %, about 60 wt. % to about 80 wt. %, about 60 wt. % to about 70 wt. %, about 70 wt. % to about 90 wt. %, about 70 wt. % to about 80 wt. %, about 80 wt. % to about 90 wt. % of the bio-based composition. In certain embodiments, the rosin or the α,β-unsaturated carboxylic acid adducted/modified rosin (or salt thereof) is about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 56, about 57, about 58, about 59, about 60, about 51, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, or about 90 wt. % of the bio-based composition.

The tall oil pitch or the α,β-unsaturated carboxylic acid adducted/modified tall oil pitch (or salt thereof) may be present in an amount of about 10 wt. % to about 70 wt. % of the bio-based composition. For example, the tall oil pitch or the α,β-unsaturated carboxylic acid adducted/modified tall oil pitch (or salt thereof) may be about 10 wt. % to about 60 wt. %, about 10 wt. % to about 50 wt. %, about 10 wt. % to about 40 wt. %, about 10 wt. % to about 30 wt. %, about 20 wt. % to about 70 wt. %, about 20 wt. % to about 60 wt. %, about 20 wt. % to about 50 wt. %, about 20 wt. % to about 40 wt. %, about 20 wt. % to about 30 wt. %, about 30 wt. % to about 70 wt. %, about 30 wt. % to about 60 wt. %, about 30 wt. % to about 50 wt. %, about 30 wt. % to about 40 wt. %, about 40 wt. % to about 70 wt. %, about 40 wt. % to about 60 wt. %, about 40 wt. % to about 50 wt. %, about 50 wt. % to about 70 wt. %, about 50 wt. % to about 60 wt. %, about 60 wt. % to about 70 wt. % of the bio-based composition. In certain embodiments, the tall oil pitch or the α,β-unsaturated carboxylic acid adducted/modified tall oil pitch (or salt thereof) is about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 56, about 57, about 58, about 59, about 60, about 51, about 62, about 63, about 64, about 65, about 66, about 67, about 68, about 69, about 70 wt. % of the bio-based composition.

The fatty acid material or the α,β-unsaturated carboxylic acid adducted/modified fatty acid material (or salt thereof) may be present in an amount of about ≤70 wt. % (e.g., about 15 wt. % to about 30 wt. %) of the bio-based binder. For example, the fatty acid material or the α,β-unsaturated carboxylic acid adducted/modified fatty acid material (or salt thereof) may be ≤about 60 wt. %, ≤about 50 wt. %, ≤about 40 wt. %, ≤about 30 wt. %, ≤about 20 wt. %, or ≤about 10 wt. % of the bio-based composition. The fatty acid material or the α,β-unsaturated carboxylic acid adducted/modified fatty acid material (or salt thereof) may be about 10 wt. % to about 70 wt. %, about 10 wt. % to about 60 wt. %, about 10 wt. % to about 50 wt. %, about 10 wt. % to about 40 wt. %, about 10 wt. % to about 30 wt. %, about 20 wt. % to about 70 wt. %, about 20 wt. % to about 60 wt. %, about 20 wt. % to about 50 wt. %, about 20 wt. % to about 40 wt. %, about 20 wt. % to about 30 wt. %, about 30 wt. % to about 70 wt. %, about 30 wt. % to about 60 wt. %, about 30 wt. % to about 50 wt. %, about 30 wt. % to about 40 wt. %, about 40 wt. % to about 70 wt. %, about 40 wt. % to about 60 wt. %, about 40 wt. % to about 50 wt. %, about 50 wt. % to about 70 wt. %, about 50 wt. % to about 60 wt. %, about 60 wt. % to about 70 wt. % of the bio-based composition.

The fatty acid material may comprise at least one saturated fatty acid (such as stearic acid) (e.g., at least two, at least three, at least four, at least five, or at least six saturated fatty acids). The fatty acid material may comprise at least one unsaturated fatty acid (at least two, at least three, at least four, at least five, or at least six unsaturated fatty acids). For example, the fatty acid material may include at least one (or at least two, at least three, or at least four) C4-C40 saturated or unsaturated fatty acid. For example, the fatty acid material may include at least one (or at least two, at least three, or at least four) C6-C26 saturated or unsaturated fatty acid. The fatty acid material may include a C4-C40, C4-C35, C4-C30, C4-C25, C4-C20, C4-C15, C10-C40, C10-C35, C10-C30, C10-C25, C10-C20, C10-C15, C15-C40, C15-C35, C15-C30, C15-C25, C15-C20, C20-C40, C20-C35, C20-C30, C20-C25, C25-C40, C25-C35, C25-C30, C30-C40, C30-C35, or C35-C40 saturated fatty acid. The fatty acid material may include a C4-C40, C4-C35, C4-C30, C4-C25, C4-C20, C4-C15, C10-C40, C10-C35, C10-C30, C10-C25, C10-C20, C10-C15, C15-C40, C15-C35, C15-C30, C15-C25, C15-C20, C20-C40, C20-C35, C20-C30, C20-C25, C25-C40, C25-C35, C25-C30, C30-C40, C30-C35, or C35-C40 unsaturated fatty acid. The fatty acid material may be for example tall oil fatty acid.

The bio-based composition may further comprise a tall oil bio fraction or an α,β-unsaturated carboxylic acid adducted/modified tall oil bio fraction (e.g., distilled tall oil, the heads stream of crude tall oil distillation, or an α,β-unsaturated carboxylic acid adducted/modified version thereof). The tall oil bio fraction (or salt thereof) may be present in an amount of about ≤90 wt. % (e.g., about 30 wt. % to about 60 wt. %) of the bio-based binder. For example, the tall oil bio fraction or the α,β-unsaturated carboxylic acid adducted/modified tall oil bio fraction (or salt thereof) may be ≤about 80 wt. %, ≤about 70 wt. %, ≤about 60 wt. %, ≤about 50 wt. %, ≤about 40 wt. %, ≤about 30 wt. %, ≤about 20 wt. %, or ≤about 10 wt. % of the bio-based composition. The tall oil bio fraction or the α,β-unsaturated carboxylic acid adducted/modified tall oil bio fraction (or salt thereof) may be about 10 wt. % to about 90 wt. %, about 10 wt. % to about 80 wt. %, about 10 wt. % to about 70 wt. %, about 10 wt. % to about 60 wt. %, about 10 wt. % to about 50 wt. %, about 10 wt. % to about 40 wt. %, about 10 wt. % to about 30 wt. %, about 10 wt. % to about 20 wt. %, about 20 wt. % to about 90 wt. %, about 20 wt. % to about 80 wt. %, about 20 wt. % to about 70 wt. %, about 20 wt. % to about 60 wt. %, about 20 wt. % to about 50 wt. %, about 20 wt. % to about 40 wt. %, about 20 wt. % to about 30 wt. %, about 30 wt. % to about 90 wt. %, about 30 wt. % to about 80 wt. %, about 30 wt. % to about 70 wt. %, about 30 wt. % to about 60 wt. %, about 30 wt. % to about 50 wt. %, about 30 wt. % to about 40 wt. %, about 40 wt. % to about 90 wt. %, about 40 wt. % to about 80 wt. %, about 40 wt. % to about 70 wt. %, about 40 wt. % to about 60 wt. %, about 40 wt. % to about 50 wt. %, about 50 wt. % to about 90 wt. %, about 50 wt. % to about 80 wt. %, about 50 wt. % to about 70 wt. %, about 50 wt. % to about 60 wt. %, about 60 wt. % to about 90 wt. %, about 60 wt. % to about 80 wt. %, about 60 wt. % to about 70 wt. %, about 70 wt. % to about 90 wt. %, about 70 wt. % to about 80 wt. %, or about 80 wt. % to about 90 wt. % of the bio-based composition.

At least one of the bio-based components is a salt. For example, at least one of: the tall oil pitch or the alpha, beta-carboxylic acid adducted/modified tall oil pitch is a salt thereof; the rosin or the alpha, beta-carboxylic acid adducted/modified rosin is a salt thereof; the fatty acid material or the alpha, beta-carboxylic adducted/modified fatty acid material is a salt thereof; the tall oil bio fraction or an alpha, beta-carboxylic adducted/modified tall oil bio fraction is a salt thereof; or a combination thereof. Each of the tall oil pitch salt, the α,β-unsaturated carboxylic acid adducted/modified tall oil pitch salt, the rosin salt, the α,β-unsaturated carboxylic acid adducted/modified rosin salt, the fatty acid material salt, the α,β-unsaturated carboxylic acid adducted/modified fatty acid material salt, the tall oil bio fraction salt, and/or the the α,β-unsaturated carboxylic acid adducted/modified tall oil bio fraction salt are individually selected from a sodium salt, a lithium salt, a zinc salt, an aluminum salt, an ammonium salt, a calcium salt, an iron salt, a magnesium salt, a potassium salt, a pyridinium salt, or a quaternary ammonium salt. For example, in certain other embodiments, at least one of the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, the tall oil bio fraction salt or the alpha, beta-carboxylic adducted/modified tall oil bio fraction salt, or a combination thereof, is a sodium salt.

In any aspect or embodiments described herein, the bio-based composition or binder of the present disclosure may have a softening point in a range of about 75° C. to about 140° C. (e.g., about 100° C. to about 120° C.). For example, the softening point of the bio-based composition may be about 75° C. to about 130° C., about 75° C. to about 120° C., about 75° C. to about 110° C., about 75° C. to about 100° C., about 75° C. to about 90° C., about 80° C. to about 140° C., about 80° C. to about 130° C., about 80° C. to about 120° C., about 80° C. to about 110° C., about 80° C. to about 100° C., about 80° C. to about 90° C., about 90° C. to about 140° C., about 90° C. to about 130° C., about 90° C. to about 120° C., about 90° C. to about 110° C., about 90° C. to about 100° C., about 100° C. to about 140° C., about 100° C. to about 130° C., about 100° C. to about 120° C., about 110° C. to about 110° C., about 110° C. to about 140° C., about 110° C. to about 130° C., about 110° C. to about 120° C., about 120° C. to about 140° C., about 120° C. to about 130° C., or about 130° C. to about 140° C. The softening point of the bio-based composition or binder may be about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 111° C., about 112° C., about 113° C., about 114° C., about 115° C., about 116° C., about 117° C., about 118° C., about 119° C., about 120° C., about 121° C., about 122° C., about 123° C., about 124° C., about 125° C., about 126° C., about 127° C., about 128° C., about 129° C., about 120° C., about 131° C., about 132° C., about 133° C., about 134° C., about 135° C., about 136° C., about 137° C., about 138° C., about 139° C., or about 140° C.

In any aspect or embodiment described herein, the bio-based composition or binder of the present disclosure may have a viscosity of less than about 30,000 cP at about 149° C. (about 300° C.); or a combination thereof. For example, the bio-based composition of the disclosure may have a viscosity of: about ≤30,000 cP; about ≤25,000 cP; about ≤20,000 cP; about ≤15,000 cP; about ≤15,000 cP; or about ≤10,000 cP at about 149° C. By way of further example, the binder of the present disclosure may have a viscosity of about 5,000 cP to about 30,000 cP; about 5,000 cP to about 25,000 cP; about 5,000 cP to about 20,000 cP; about 5,000 cP to about 15,000 cP; about 5,000 cP to about 10,000 cP; about 10,000 cP to about 30,000 cP; about 10,000 cP to about 25,000 cP; about 10,000 cP to about 20,000 cP; about 10,000 cP to about 15,000 cP; about 15,000 cP to about 30,000 cP; about 15,000 cP to about 25,000 cP; about 15,000 cP to about 20,000 cP; about 20,000 cP to about 30,000 cP; about 20,000 cP to about 25,000 cP; about 25,000 cP to about 30,000 cP at about 149° C.

The present disclosure also provides a method of making the bio-based composition or binder of the present disclosure. The method may comprise either: (a) mixing tall oil pitch with (i) rosin or fatty acid material, (ii) the rosin and a fatty acid material, (iii) the the rosin or the fatty acid material, and a tall oil bio fraction, or (iv) the rosin, the fatty acid material, and the tall oil bio fraction, wherein at least one of the pitch, the rosin, the fatty acid material, the tall oil bio fraction, or a combination thereof is a salt thereof; or (b) mixing at least one alpha, beta-unsaturated carboxylic acid selected from the group consisting of acrylic acid, maleic acid, maleic anhydride, fumaric acid, acrylic acid, methacrylic acid, or a combination thereof, to a mixture of: (i) the tall oil pitch and the rosin or the fatty acid material; (ii) the rosin, the tall oil pitch, and the fatty acid material; (iii) the tall oil pitch, the tall oil bio fraction, and the rosin or the fatty acid material,; or (iv) the rosin, the tall oil pitch, the fatty acid material, and the tall oil bio fraction.

At least one of the pitch, the rosin, the fatty acid material, and the tall oil bio fraction of (a) above may be an alpha, beta-unsaturated carboxylic acid adducted/modified pitch, an alpha, beta-unsaturated carboxylic acid adducted/modified rosin, an alpha, beta-unsaturated carboxylic acid adducted/modified fatty acid material, an alpha, beta-unsaturated carboxylic acid adducted/modified tall oil bio fraction, or a combination therefore produced by mixing at least one alpha, beta-unsaturated carboxylic acid selected from the group consisting of acrylic acid, maleic acid, maleic anhydride, fumaric acid, acrylic acid, methacrylic acid, or a combination thereof, to a molten rosin, the pitch, the fatty acid material, the tall oil bio fraction, or a salt thereof.

The bio-based composition may have at least one of the following: (1) the tall oil pitch or the alpha, beta-unsaturated carboxylic acid adducted/modified tall oil pitch is present in an amount of about 10 wt %. to about 70 wt. % of the bio-based binder; (2) the rosin or the alpha, beta-unsaturated carboxylic acid adducted/modified rosin is present in an amount of about 30 wt. % to about 90 wt. % of the bio-based binder; (3) the fatty acid material or the alpha, beta-unsaturated carboxylic acid adducted/modified fatty acid material is present in an amount of about ≤70 wt. % of the bio-based binder; (4) the tall oil bio fraction or the alpha, beta-unsaturated carboxylic acid adducted/modified tall oil bio fraction is present in an amount of about ≤90 wt. % of the bio-based binder; or (5) a combination thereof.

The bio-based composition may have at least one of the following: the tall oil pitch or the alpha, beta-carboxylic acid adducted/modified tall oil pitch is a salt thereof; the rosin or the alpha, beta-carboxylic acid adducted/modified rosin is a salt thereof; the fatty acid material or the alpha, beta-carboxylic adducted/modified fatty acid material is a salt thereof; the tall oil bio fraction or an alpha, beta-carboxylic adducted/modified tall oil bio fraction is a salt thereof; or a combination thereof.

The bio-based composition may have at least one of the following: (1) the tall oil pitch salt or the alpha, beta-carboxylic acid adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (2) the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (3) the fatty acid material salt or the alpha, beta-carboxylic acid adducted/modified tall oil material salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; (4) the tall oil bio fraction salt or the alpha, beta-carboxylic acid adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; or (5) a combination thereof. In any aspect or embodiment describe herein, at least one of the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, the tall oil bio fraction salt or the alpha, beta-carboxylic adducted/modified tall oil bio fraction salt, or a combination thereof, is a sodium or calcium salt.

The method may further comprise melting the rosin, e.g., by heating the rosin to 200° C. to about 260° C. (e.g., about 220° C.). The melting/heating may be performed under a chemically inert gas blanket (e.g., nitrogen, argon, helium, neon, krypton, xenon, or radon). The α,β-unsaturated carboxylic acid is added to the molten rosin or a mixture of: (i) rosin (e.g., molten rosin) and the tall oil pitch; (ii) the rosin (e.g., molten rosin), the tall oil pitch, and the fatty acid material; (iii) the rosin (e.g., molten rosin), the tall oil pitch, and the tall oil bio fraction; or (iv) the rosin (e.g., molten rosin), the tall oil pitch, the fatty acid material, and the tall oil bio fraction. The α,β-unsaturated carboxylic acid may be added at a rate of about 0.2 g/min to about 3.0 g/min (e.g., about 0.5 g/min to about 2.0 g/min or about 1 g/min). The carboxylic acid and molten rosin may be mixed or stirred for about 45 minutes to about 10 hours (e.g., about 1.5 hours to about 4.5 hours or about 3 hours), which may be performed at about 200° C. to about 260° C. (e.g., 220° C.)

The method may comprise melting or heating the carboxylic adducted/modified rosin to about 160° C. to about 210° C. to melt or maintain the molten state of the carboxylic adducted/modified rosin. The tall oil pitch is added to the molten carboxylic acid adducted/modified rosin. The mixture may be further mixed for an additional about 30 minutes to about 5 hours (e.g., about 1 hour to about 3 hours or about 2 hours).

Furthermore, as discussed herein, a fatty acid material (as discussed herein) and/or a tall oil bio fraction (as discussed herein) may be added, e.g., under a chemically inert gas blanket (e.g., nitrogen, argon, helium, neon, krypton, xenon, or radon) to the rosin (e.g., molten rosin) with or without the tall oil pitch prior to the addition of the α,β-unsaturated carboxylic acid or added to an α,β-unsaturated carboxylic adducted/modified rosin or tall oil pitch with or without tall oil pitch or rosin, respectively.

The resultant bio-based composition may have at least one of the following: a softening point in a range of about 75° C. to about 140° C. (e.g., about 100° C. to about 120° C.); a viscosity of less than about 30,000 cP at about 300° F. (about 149° C.); or a combination thereof.

In a further aspect, the present disclosure provides an article, e.g. propellable target, formed from a composition comprised of particulate filler and the bio-based or biodegradable composition or binder of the present disclosure. The particulate filler may be present in an amount of about 50 wt. % to about 95 wt. % of the article, e.g. a propellable target. For example, the particular filler may be present in about 50 wt. % to about 95 wt. %, about 50 wt. % to about 90 wt. %, about 50 wt. % to about 85 wt. %, about 50 wt. % to about 80 wt. %, about 50 wt. % to about 75 wt. %, about 50 wt. % to about 70 wt. %, about 50 wt. % to about 65 wt. %, about 50 wt. % to about 60 wt. %, about 55 wt. % to about 95 wt. %, about 55 wt. % to about 90 wt. %, about 55 wt. % to about 85 wt. %, about 55 wt. % to about 80 wt. %, about 55 wt. % to about 75 wt. %, about 55 wt. % to about 70 wt. %, about 55 wt. % to about 65 wt. %, about 60 wt. % to about 95 wt. %, about 60 wt. % to about 95 wt. %, about 60 wt. % to about 90 wt. %, about 60 wt. % to about 85 wt. %, about 60 wt. % to about 80 wt. %, about 60 wt. % to about 75 wt. %, about 60 wt. % to about 70 wt. %, about 65 wt. % to about 95 wt. %, about 65 wt. % to about 90 wt. %, about 65 wt. % to about 85 wt. %, about 65 wt. % to about 80 wt. %, about 65 wt. % to about 75 wt. %, about 70 wt. % to about 95 wt. %, about 70 wt. % to about 90 wt. %, about 70 wt. % to about 85 wt. %, about 70 wt. % to about 80 wt. %, about 75 wt. % to about 95 wt. %, about 75 wt. % to about 90 wt. %, about 75 wt. % to about 85 wt. %, about 80 wt. % to about 95 wt. %, about 80 wt. % to about 90 wt. %, or about 85 wt. % to about 95 wt. % of the article, e.g. a propellable target, composition.

The bio-based composition or binder of the present disclosure may be present in an amount no greater than 50 wt. % of the article, e.g. propellable target. For example, the bio-based composition or binder of the present disclosure may be ≤50 wt. %, ≤45 wt. %, ≤40 wt. %, ≤35 wt. %, ≤30 wt. %, ≤25 wt. %, ≤20 wt. %, ≤15 wt. %, ≤10 wt. %, ≤5 wt. %, about 5 wt. % to about 50 wt. %, about 5 wt. % to about 45 wt. %, about 5 wt. % to about 40 wt. %, about 5 wt. % to about 35 wt. %, about 5 wt. % to about 30 wt. %, about 5 wt. % to about 25 wt. %, about 5 wt. % to about 20 wt. %, about 5 wt. % to about 15 wt. %, about 5 wt. % to about 10 wt. %, about 10 wt. % to about 50 wt. %, about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 10 wt. % to about 20 wt. %, about 10 wt. % to about 15 wt. %, about 15 wt. % to about 50 wt. %, about 15 wt. % to about 45 wt. %, about 15 wt. % to about 40 wt. %, about 15 wt. % to about 35 wt. %, about 15 wt. % to about 30 wt. %, about 15 wt. % to about 25 wt. %, about 15 wt. % to about 20 wt. %, about 20 wt. % to about 50 wt. %, about 20 wt. % to about 45 wt. %, about 20 wt. % to about 40 wt. %, about 20 wt. % to about 35 wt. %, about 20 wt. % to about 30 wt. %, about 20 wt. % to about 25 wt. %, about 25 wt. % to about 50 wt. %, about 25 wt. % to about 45 wt. %, about 25 wt. % to about 40 wt. %, about 25 wt. % to about 35 wt. %, about 25 wt. % to about 30 wt. %, about 30 wt. % to about 50 wt. %, about 30 wt. % to about 45 wt. %, about 30 wt. % to about 40 wt. %, about 30 wt. % to about 35 wt. %, about 35 wt. % to about 50 wt. %, about 35 wt. % to about 45 wt. %, about 35 wt. % to about 40 wt. %, about 40 wt. % to about 50 wt. %, about 40 wt. % to about 45 wt. %, or about 45 wt. % to about 50 wt. % of the article, e.g. a propellable target composition.

The particulate filler may be an inorganic filler, such as one or more (e.g., at least one, two, three, four, or five) of clay (e.g., the clay may be at least one of Zeolite clay, Bentonite clay, Montmorillonite clay, Illite clay, French Green clay, Pascalite clay, Redmond clay, Terramin clay, Living clay, Fuller's Earth clay, Ormalite clay, Vitallite clay, Rectorite clay, Cordierite, kaolin clay, ball clay or a combination thereof), synthetic clay, calcium carbonate, magnesium carbonate, calcium hydroxide, calcium aluminate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, or a combination thereof. In a particular embodiment, the inorganic filler is at least one of clay, synthetic clay, calcium carbonate, magnesium carbonate, calcium hydroxide, calcium aluminate, limestone, or a combination thereof.

The target may further comprise pigment (e.g., yellow, orange, white, green, purple, pink, black, grey, etc.) so that the target is more easily viewed by the marksman when in motion. One skilled in the art appreciates that the particular color pigment utilized depend upon the targets application.

The present disclosure further provides a method of making an article, e.g. propellable target. The method comprises: mixing the bio-based or biodegradable composition or binder of the present disclosure (e.g., at any concentration described herein) and a particulate filler (e.g., at any concentration described herein); and forming the mixture into a shape. For example, the particulate filler of the method may be present in an amount of about 50 wt. % to about 95 wt. % of the article, e.g. a propellable target, the bio-based composition of the method may be present in an amount no greater than 50 wt. % of the article, e.g. a propellable target, or a combination thereof.

The particulate filler of the method may be an inorganic filler. The inorganic filler may be any suitable inorganic filler. For example, the inorganic filler may be at least one of clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, or a combination thereof.

The composition that is formed into a shape may be mixed until a smooth, homogeneous blend is formed. The material can then, for example, be removed from the mixing vessel and formed into a huge variety of articles/shapes using any known shaping method known, such as shaping methods in the art of plastic materials and/or ceramics. For example, the mixture may be formed into the desired shape (e.g., a propellable target as described herein) by applying the mixture to a mold (e.g., compression molding, blow molding, injection molding, die press molding, etc.), extruding the mixture, hot pressing the mixture, or otherwise processing the mixture to an acceptable physical form.

The following examples are intended to illustrate, but in no way limit, the invention as claimed.

### EXAMPLES

### Preparation of Inventive Example 1

Rosin (621.21 g of Ingevity® Altapyne Rosin SS-A) was added to a 3 L round bottom flask equipped with an overhead stirrer, N₂ inlet, temperature probe, and condenser fitted with a Dean Stark trap. The solid rosin was heated to 200° C. to melt and maleic anhydride (151.52 g) added. The mixture was stirred at 200° C. for approximately 1 hour. Pitch (621.21 g of Ingevity® Tallex Pitch) was added to the maleated rosin and the mixture was mixed thoroughly. An aqueous solution of 50% (wt/wt) NaOH (206.06 g) was added over approximately 1 hour using a N₂ sparge to aid in the removal of the water from the reaction mixture. After the addition of the NaOH was complete, the temperature was increased to about 230° C. and stirred for approximately 1 hour. The mixture was then cooled to about 210° C. and discharged to provide a brittle product with a softening point of 111.6° C. and a viscosity of 20,020 cP (S28) at 149° C. (about 300° F.).

### Preparation of Inventive Example 2

Rosin (200 g of Ingevity® Altapyne Rosin SS-A) and Pitch (200 g of Ingevity® Tallex Pitch) was added to a 1-L round bottom flask equipped with an overhead stirrer, N2 inlet, temperature probe, and condenser fitted with a Dean Stark trap. The mixture was heated to approximately 180° C. to melt and maleic anhydride (50 g) was added. The temperature was increased to approximately 215° C. and the mixture was stirred for approximately 1 hour. MgO (20 g) was slowly added to the maleated rosin/pitch mixture. The mixture was stirred with a N₂ sparge for approximately 1.5 hours and discharged to provide a brittle product with a softening point of about 132° C.

### Preparation of Inventive Example 3

Pitch (211.1 g of Ingevity® Tallex Pitch) was added to a 1-L round bottom flask equipped with an overhead stirrer, N2 inlet, temperature probe, and condenser fitted with a Dean Stark trap. The pitch was heated to about 180° C. and an aqueous solution of 50% (wt/wt) NaOH (11.6 g) was added over approximately 10 minutes. The mixture was heated to about 220° C. and Rosin (337.8 g of Ingevity® Altapyne Rosin SS-A) was added. Ca(OH)₂ (39.6 g) was added to the mixture over approximately 15 minutes. A N₂ sparge was used to aid in the removal of the evolved water. After the Ca(OH)₂ addition was complete, the temperature was increased to about 250° C. and the mixture was stirred for about 1.5 hour. The mixture was cooled to about 220° C. and discharged to provide a brittle product with a softening point of about 106° C. and viscosity of about 5,015 cP (S28) at about 149° C. (about 300° F.).

### Preparation of Inventive Example 4

Pitch (275.6 g of Ingevity® Tallex Pitch) was added to a 1-L round bottom flask equipped with an overhead stirrer, N2 inlet, temperature probe, and condenser fitted with a Dean Stark trap. The pitch was heated to about 180° C. and an aqueous solution of 50% (wt/wt) NaOH (14.6 g) was added over approximately 10 minutes. The mixture was heated to about 220° C. and rosin (275.6 g of Ingevity® Altapyne Rosin SS-A) was added. Ca(OH)₂ (32.2 g) and glacial acetic acid (2 g) was added to the mixture over approximately 45 minutes. A N₂ sparge was used to aid in the removal of the evolved water. After the Ca(OH)₂ and acetic acid addition was complete, the temperature was increased to about 250° C. and the mixture was stirred for about 40 minutes. The mixture was cooled to about 220° C. and discharged to provide a brittle product with a softening point of about 105° C. and viscosity of about 5,155 cP (S28) at about 149° C. (about 300° F.).

### Preparation of Inventive Example 5

Pitch (289.8 g of Ingevity® Tallex Pitch) was added to a 1-L round bottom flask equipped with an overhead stirrer, N2 inlet, temperature probe, and condenser fitted with a Dean Stark trap. The pitch was heated to about 180° C. and an aqueous solution of 50% (wt/wt) NaOH (15.9 g) was added over approximately 10 minutes. The mixture was heated to about 220° C. and rosin (261.1 g of Ingevity® Altapyne Rosin SS-A) was added. Ca(OH)₂ (32.2 g) and Ca(OAc)₂ (2.1 g) was added to the mixture over approximately 30 minutes. A N₂ sparge was used to aid in the removal of the evolved water. After the Ca(OH)₂ and Ca(OAc)₂ addition was complete, the temperature was increased to about 250° C. and the mixture was stirred for about 1 hour. The mixture was cooled to about 220° C. and discharged to provide a brittle product with a softening point of about 110° C. and viscosity of about 10,450 cP (S28) at about 149° C. (300° F.).

### Use of Inventive Example 4 in a Standard Marksman Shooting Target Formulation

Inventive Example 4 (122.5 g) was melted at about 177-180° C. in a metal pint can equipped with an overhead stirrer, temperature probe, and nitrogen inlet. The stirrer was set to about 170 rpm and limestone (CaCO₃) (227.4 g) was added portion wise over approximately 20 minutes while maintaining the temperature>177° C. After the addition of the limestone was complete, the mixture was stirred at 180-190° C. for about 5 minutes and discharged to form a solid sheet which was approximately 0.25 inches thick. The properties of the resultant formulation display characteristics that may be applicable to the shooting target industry, such as hardness, brittleness, and the ability to shatter upon being struck with a hard object, as discussed herein.

### Specific Embodiments

According to an aspect, the present disclosure provides a bio-based binder comprising (i) tall oil pitch and (ii) rosin and/or a fatty acid material, wherein the tall oil pitch, the rosin, and/or the fatty acid material is a salt thereof.

In any aspect or embodiment described herein, the tall oil pitch is an alpha, beta-unsaturated carboxylic acid adducted/modified tall oil pitch; the rosin is an alpha, beta-unsaturated carboxylic acid adducted/modified rosin; the fatty acid material is an alpha, beta-unsaturated carboxylic acid adducted/modified fatty acid material; and/or a combination thereof.

In any aspect or embodiment described herein, the fatty acid material is a tall oil fatty acid.

In any aspect or embodiment described herein, the bio-based composition further comprising a tall oil bio fraction.

In any aspect or embodiment described herein, the tall oil bio fraction is distilled tall oil or the heads fraction of crude tall oil distillation.

In any aspect or embodiment described herein, the alpha, beta-unsaturated carboxylic acid adducted/modified pitch, the alpha, beta-unsaturated carboxylic acid adducted/modified rosin, and/or the alpha, beta-unsaturated carboxylic acid adducted/modified fatty acid material is produced by: (a) mixing at least one alpha, beta-unsaturated carboxylic acid selected from the group consisting of acrylic acid, maleic acid, maleic anhydride, fumaric acid, methacrylic acid, or a combination thereof, to a molten rosin, the pitch, or the fatty acid material; or (b) mixing at least one alpha, beta-unsaturated carboxylic acid selected from the group consisting of acrylic acid, maleic acid, maleic anhydride, fumaric acid, methacrylic acid, or a combination thereof, to a mixture of: (i) the tall oil pitch, and the rosin or the fatty acid material; (ii) the rosin, the tall oil pitch, and the fatty acid material; (iii) the tall oil pitch, a tall oil bio fraction, and the rosin or the fatty acid material; or (iv) the rosin, the tall oil pitch, the fatty acid material, and a tall oil bio fraction.

In any aspect or embodiment described herein, the tall oil pitch or the alpha, beta-unsaturated carboxylic acid adducted/modified tall oil pitch is present in an amount of about 10 wt. % to about 70 wt. % of the bio-based binder.

In any aspect or embodiment described herein, the rosin or the alpha, beta-carboxylic acid adducted/modified rosin is present in an amount of about 30 wt. % to about 90 wt. % of the bio-based binder.

In any aspect or embodiment described herein, the fatty acid material or the alpha, beta-unsaturated carboxylic acid adducted/modified fatty acid material is present in an amount of about 70 wt. % or less of the bio-based binder.

In any aspect or embodiment described herein, the tall oil bio fraction the alpha, beta-unsaturated carboxylic acid adducted/modified tall oil bio fraction is present in an amount of about 90 wt. % or less of the bio-based binder.

In any aspect or embodiment described herein, the tall oil pitch or the alpha, beta-carboxylic acid adducted/modified tall oil pitch is a salt thereof; the rosin or the alpha, beta-carboxylic acid adducted/modified rosin is a salt thereof; the fatty acid material or the alpha, beta-carboxylic adducted/modified fatty acid material is a salt thereof; and/or the tall oil bio fraction or an alpha, beta-carboxylic adducted/modified tall oil bio fraction is a salt thereof.

In any aspect or embodiment described herein, the tall oil pitch salt or the alpha, beta-carboxylic adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt.

In any aspect or embodiment described herein, the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt.

In any aspect or embodiment described herein, the fatty acid material salt or the alpha, beta-carboxylic adducted/modified fatty acid material is a sodium salt, a lithium salt, a zinc salt, an aluminum salt, an ammonium salt, a calcium salt, an iron salt, a magnesium salt, a potassium salt, a pyridinium salt, or a quaternary ammonium salt.

In any aspect or embodiment described herein, the tall oil bio fraction salt or the alpha, beta-carboxylic adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt.

In any aspect or embodiment described herein, the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, and/or the tall oil bio fraction salt or the alpha, beta-carboxylic adducted/modified tall oil bio fraction salt is a sodium salt.

In any aspect or embodiment described herein, the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, and/or the tall oil bio fraction salt or the alpha, beta-carboxylic adducted/modified tall oil bio fraction salt is a calcium salt.

In any aspect or embodiment described herein, the bio-based binder has: a softening point in a range of about 75° C. to about 140° C. (e.g., about 100° C. to about 120° C.); and/or a viscosity of less than about 30,000 cP at about 149° C.

According to a further aspect, the present disclosure provides an article formed from a composition comprised of particulate filler and the bio-based binder of the present disclosure.

In any aspect or embodiment described herein, the particulate filler is present in an amount of about 50 wt. % to about 95 wt. % of the article; and/or the bio-based binder is present in an amount no greater than 50 wt. % of the article.

In any aspect or embodiment described herein, the particulate filler is an inorganic filler.

In any aspect or embodiment described herein, the inorganic filler is clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, and/or minerals.

In any aspect or embodiment described herein, the inorganic filler is clay, synthetic clay, calcium carbonate, magnesium carbonate, calcium hydroxide, calcium aluminate, magnesium carbonate, and/or limestone.

In any aspect or embodiment described herein, the article is a target.

In any aspect or embodiment described herein, the target is a propellable target.

According to another aspect, the present disclosure provides a method of making a bio-based binder. The method comprises either: (a) mixing tall oil pitch with (i) rosin or fatty acid material, (ii) the rosin and a fatty acid material, (iii) the a tall oil bio fraction and the rosin or the fatty acid material, or (iv) the rosin, the fatty acid material, and the tall oil bio fraction, wherein at least one of the pitch, the rosin, the fatty acid material, the tall oil bio fraction, or a combination thereof is a salt thereof; or (b) mixing at least one alpha, beta-unsaturated carboxylic acid selected from the group consisting of acrylic acid, maleic acid, maleic anhydride, fumaric acid, acrylic acid, methacrylic acid, or a combination thereof, to a mixture of: (i) the tall oil pitch and the rosin or the fatty acid material; (ii) the rosin, the tall oil pitch, and the fatty acid material; (iii) the tall oil pitch, the tall oil bio fraction, and the rosin or the fatty acid material,; or (iv) the rosin, the tall oil pitch, the fatty acid material, and the tall oil bio fraction.

In any aspect or embodiment described herein, the pitch, the rosin, the fatty acid material, and/or the tall oil bio fraction of (a) is an alpha, beta-unsaturated carboxylic acid adducted/modified pitch, an alpha, beta-unsaturated carboxylic acid adducted/modified rosin, an alpha, beta-unsaturated carboxylic acid adducted/modified fatty acid material, an alpha, beta-unsaturated carboxylic acid adducted/modified tall oil bio fraction, or a combination therefore produced by mixing at least one alpha, beta-unsaturated carboxylic acid selected from the group consisting of acrylic acid, maleic acid, maleic anhydride, fumaric acid, acrylic acid, methacrylic acid, or a combination thereof, to a molten rosin, the pitch, the fatty acid material, the tall oil bio fraction, or a salt thereof.

In any aspect or embodiment described herein, the tall oil pitch or the alpha, beta-unsaturated carboxylic acid adducted/modified tall oil pitch is present in an amount of about 10 wt %. to about 70 wt. % of the bio-based binder; the rosin or the alpha, beta-unsaturated carboxylic acid adducted/modified rosin is present in an amount of about 30 wt. % to about 90 wt. % of the bio-based binder; the fatty acid material or the alpha, beta-unsaturated carboxylic acid adducted/modified fatty acid material is present in an amount of about ≤70 wt. % of the bio-based binder; and/or the tall oil bio fraction or the alpha, beta-unsaturated carboxylic acid adducted/modified tall oil bio fraction is present in an amount of about ≤90 wt. % of the bio-based binder.

In any aspect or embodiment described herein, the tall oil pitch or the alpha, beta-carboxylic acid adducted/modified tall oil pitch is a salt thereof; the rosin or the alpha, beta-carboxylic acid adducted/modified rosin is a salt thereof; the fatty acid material or the alpha, beta-carboxylic adducted/modified fatty acid material is a salt thereof; and/or the tall oil bio fraction or an alpha, beta-carboxylic adducted/modified tall oil bio fraction is a salt thereof.

In any aspect or embodiment described herein, the tall oil pitch salt or the alpha, beta-carboxylic acid adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; the fatty acid material salt or the alpha, beta-carboxylic acid adducted/modified fatty acid material salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; and/or the tall oil bio fraction salt or the alpha, beta-carboxylic acid adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt.

In any aspect or embodiment described herein, the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, and/or the tall oil bio fraction salt or the alpha, beta-carboxylic adducted/modified tall oil bio fraction salt is a sodium or calcium salt.

In any aspect or embodiment described herein, the bio-based binder has: a softening point in a range of about 75° C. to about 140° C. (e.g., about 100° C. to about 120° C.); and/or a viscosity of less than about 30,000 cP at about 149° C.

According to yet another aspect, the present disclosure provides a method of making an article. The method comprises: mixing the bio-binder of the present disclosure or produced according to the methods of the present disclosure and a particulate filler; and forming the mixture into a shape.

In any aspect or embodiment described herein, the particulate filler is present in an amount of about 50 wt. % to about 95 wt. % of the article; and/or the bio-based binder is present in an amount no greater than 50 wt. % of the article.

In any aspect or embodiment described herein, the particulate filler is an inorganic filler.

In any aspect or embodiment described herein, the inorganic filler is clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, and/or minerals.

In any aspect or embodiment described herein, the inorganic filler is clay, synthetic clay, calcium carbonate, magnesium carbonate, calcium hydroxide, calcium aluminate, magnesium carbonate, and/or limestone.

In any aspect or embodiment described herein, forming the mixture into a shape comprises applying the mixture to a mold or extruding the mixture.

In any aspect or embodiment described herein, the article is a target.

In any aspect or embodiment described herein, the target is a propellable target.

As would be understood by those of skill in the art, certain quantities, amounts, and measurements are subject to theoretical and/or practical limitations in precision, which are inherent to some of the instruments and/or methods. Therefore, unless otherwise indicated, it is contemplated that claimed amounts encompass a reasonable amount of variation.

It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims.

What is claimed is:

1. A bio-based binder comprising tall oil pitch and at least one of rosin, a fatty acid material, or a combination thereof, wherein at least one of the tall oil pitch, the rosin, the fatty acid material, or a combination thereof is a salt thereof.

2. The bio-based binder of claim 1, wherein at least one of:
the tall oil pitch is an alpha, beta-unsaturated carboxylic acid adducted/modified tall oil pitch;
the rosin is an alpha, beta-unsaturated carboxylic acid adducted/modified rosin;
the fatty acid material is an alpha, beta-unsaturated carboxylic acid adducted/modified fatty acid material;
the bio-based binder further comprises a tall oil bio fraction or
a combination thereof.

3. The bio-based binder of claim 1, wherein the fatty acid material is a tall oil fatty acid.

4. The bio-based binder of claim 2, wherein the tall oil bio fraction is distilled tall oil or the heads fraction of crude tall oil distillation.

5. The bio-based binder of claim 2, wherein the alpha, beta-unsaturated carboxylic acid adducted/modified pitch, the alpha, beta-unsaturated carboxylic acid adducted/modified rosin, and/or the alpha, beta-unsaturated carboxylic acid adducted/modified fatty acid material is produced by:
mixing at least one alpha, beta-unsaturated carboxylic acid selected from the group consisting of acrylic acid, maleic acid, maleic anhydride, fumaric acid, methacrylic acid, or a combination thereof, to a molten rosin, the pitch, or the fatty acid material; or
mixing at least one alpha, beta-unsaturated carboxylic acid selected from the group consisting of acrylic acid, maleic acid, maleic anhydride, fumaric acid, methacrylic acid, or a combination thereof, to a mixture of: (i) the tall oil pitch, and the rosin or the fatty acid material; (ii) the rosin, the tall oil pitch, and the fatty acid material; (iii) the tall oil pitch, a tall oil bio fraction, and the rosin or the fatty acid material; or (iv) the rosin, the tall oil pitch, the fatty acid material, and a tall oil bio fraction.

6. The bio-based binder of claim 1, wherein the tall oil pitch or the alpha, beta-unsaturated carboxylic acid adducted/modified tall oil pitch is present in an amount of about 10 wt. % to about 70 wt. % of the bio-based binder.

7. The bio-based binder of claim 1, wherein the rosin or the alpha, beta-carboxylic acid adducted/modified rosin is present in an amount of about 30 wt. % to about 90 wt. % of the bio-based binder.

8. The bio-based binder of claim 2, wherein the fatty acid material or the alpha, beta-unsaturated carboxylic acid adducted/modified fatty acid material is present in an amount of about 70 wt. % or less of the bio-based binder.

9. The bio-based binder of claim 2, wherein the tall oil bio fraction the alpha, beta-unsaturated carboxylic acid adducted/modified tall oil bio fraction is present in an amount of about 90 wt. % or less of the bio-based binder.

10. The bio-based binder of claim 1, wherein at least one of:
the tall oil pitch or the alpha, beta-carboxylic acid adducted/modified tall oil pitch is a salt thereof;
the rosin or the alpha, beta-carboxylic acid adducted/modified rosin is a salt thereof;
the fatty acid material or the alpha, beta-carboxylic adducted/modified fatty acid material is a salt thereof;
the tall oil bio fraction or an alpha, beta-carboxylic adducted/modified tall oil bio fraction is a salt thereof; or
a combination thereof.

11. The bio-based binder of claim 10, wherein at least one of:
the tall oil pitch salt or the alpha, beta-carboxylic adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt;
the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt;
the fatty acid material salt or the alpha, beta-carboxylic adducted/modified fatty acid material is a sodium salt, a lithium salt, a zinc salt, an aluminum salt, an ammonium salt, a calcium salt, an iron salt, a magnesium salt, a potassium salt, a pyridinium salt, or a quaternary ammonium salt;
the tall oil bio fraction salt or the alpha, beta-carboxylic adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; or
a combination thereof.

12. The bio-based binder of claim 11, wherein at least one of the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, the tall oil bio fraction salt or the alpha, beta-carboxylic adducted/modified tall oil bio fraction salt, or a combination thereof, is a sodium salt.

13. The bio-based binder of claim 1, wherein the bio-based binder has at least one of the following:
a softening point in a range of about 75° C. to about 140° C. (e.g., about 100° C. to about 120° C.);
a viscosity of less than about 30,000 cP at about 149° C.;
or a combination thereof.

14. An article formed from a composition comprised of particulate filler and the bio-based binder of claim 1.

15. The article of claim 14, wherein at least one the following:
the particulate filler is present in an amount of about 50 wt. % to about 95 wt. % of the article;
the bio-based binder is present in an amount no greater than 50 wt. % of the article;
the particulate filler is an inorganic filler;
the article is a target; or
a combination thereof.

16. The article of claim 15, wherein the inorganic filler is at least one of clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, or a combination thereof.

17. The article of claim 15, wherein the target is a propellable target.

18. A method of making a bio-based binder, the method comprising either:
(a) mixing tall oil pitch with (i) rosin or fatty acid material, (ii) the rosin and a fatty acid material, (iii) the tall oil bio fraction and the rosin or the fatty acid material, or (iv) the rosin, the fatty acid material, and the tall oil bio fraction, wherein at least one of the pitch, the rosin, the fatty acid material, the tall oil bio fraction, or a combination thereof is a salt thereof; or
(b) mixing at least one alpha, beta-unsaturated carboxylic acid selected from the group consisting of acrylic acid, maleic acid, maleic anhydride, fumaric acid, acrylic acid, methacrylic acid, or a combination thereof, to a mixture of: (i) the tall oil pitch and the rosin or the fatty acid material; (ii) the rosin, the tall oil pitch, and the fatty acid material; (iii) the tall oil pitch, the tall oil bio fraction, and the rosin or the fatty acid material,; or (iv) the rosin, the tall oil pitch, the fatty acid material, and the tall oil bio fraction.

19. The method of claim 18, wherein at least one of the pitch, the rosin, the fatty acid material, the tall oil bio fraction, or a combination thereof, of (a) is an alpha, beta-unsaturated carboxylic acid adducted/modified pitch, an alpha, beta-unsaturated carboxylic acid adducted/modified rosin, an alpha, beta-unsaturated carboxylic acid adducted/modified fatty acid material, an alpha, beta-unsaturated carboxylic acid adducted/modified tall oil bio fraction, or a combination therefore produced by mixing at least one alpha, beta-unsaturated carboxylic acid selected from the group consisting of acrylic acid, maleic acid, maleic anhydride, fumaric acid, acrylic acid, methacrylic acid, or a combination thereof, to a molten rosin, the pitch, the fatty acid material, the tall oil bio fraction, or a salt thereof.

20. The method of claim 18, wherein at least one of the following:
the tall oil pitch or the alpha, beta-unsaturated carboxylic acid adducted/modified tall oil pitch is present in an amount of about 10 wt %. to about 70 wt. % of the bio-based binder;
the rosin or the alpha, beta-unsaturated carboxylic acid adducted/modified rosin is present in an amount of about 30 wt. % to about 90 wt. % of the bio-based binder;
the fatty acid material or the alpha, beta-unsaturated carboxylic acid adducted/modified fatty acid material is present in an amount of about ≤70 wt. % of the bio-based binder;
the tall oil bio fraction or the alpha, beta-unsaturated carboxylic acid adducted/modified tall oil bio fraction is present in an amount of about ≤90 wt. % of the bio-based binder; or
a combination thereof.

21. The method of claim 18, wherein at least one of:
the tall oil pitch or the alpha, beta-carboxylic acid adducted/modified tall oil pitch is a salt thereof;
the rosin or the alpha, beta-carboxylic acid adducted/modified rosin is a salt thereof;
the fatty acid material or the alpha, beta-carboxylic adducted/modified fatty acid material is a salt thereof;
the tall oil bio fraction or an alpha, beta-carboxylic adducted/modified tall oil bio fraction is a salt thereof; or
a combination thereof.

22. The method of claim 21, wherein at least one of:
the tall oil pitch salt or the alpha, beta-carboxylic acid adducted/modified tall oil pitch salt is a sodium salt, a lithium salt, a zinc salt, an aluminum salt, an ammonium salt, a calcium salt, an iron salt, a magnesium salt, a potassium salt, a pyridinium salt, or a quaternary ammonium salt;
the rosin salt or the alpha, beta-carboxylic acid adducted/modified rosin salt is a sodium salt, a lithium salt, a zinc salt, an aluminum salt, an ammonium salt, a calcium salt, an iron salt, a magnesium salt, a potassium salt, a pyridinium salt, or a quaternary ammonium salt;
the fatty acid material salt or the alpha, beta-carboxylic acid adducted/modified fatty acid material salt is a sodium salt, a lithium salt, a zinc salt, an aluminum salt, an ammonium salt, a calcium salt, an iron salt, a magnesium salt, a potassium salt, a pyridinium salt, or a quaternary ammonium salt;
the tall oil bio fraction salt or the alpha, beta-carboxylic acid adducted/modified tall oil bio fraction salt is a sodium salt, a lithium salt, a zinc salt, an aluminum salt, an ammonium salt, a calcium salt, an iron salt, a magnesium salt, a potassium salt, a pyridinium salt, or a quaternary ammonium salt; or
a combination thereof.

23. The method of claim 21, wherein at least one of the tall oil pitch salt or the alpha, beta-carboxylic adducted/modified tall oil pitch salt, the rosin salt or the alpha, beta-carboxylic acid adducted/modified rosin salt, the fatty acid material salt or the alpha, beta-carboxylic adducted/modified fatty acid material salt, the tall oil bio fraction salt or the alpha, beta-carboxylic adducted/modified tall oil bio fraction salt, or a combination thereof, is a sodium salt.

24. The method of claim 18, wherein the bio-based binder has at least one of the following:
a softening point in a range of about 75° C. to about 140° C. (e.g., about 100° C. to about 120° C.);
a viscosity of less than about 30,000 cP at about 149° C.;
or a combination thereof.

25. A method of making an article, the method comprising:
mixing the bio-binder of claim 1 or produced according to the methods of claims 18 and a particulate filler; and
forming the mixture into a shape.

26. The method of claim 25, wherein at least one of the following:
the particulate filler is present in an amount of about 50 wt. % to about 95 wt. % of the article;
the bio-based binder is present in an amount no greater than 50 wt. % of the article; or
a combination thereof.

27. The method of claim 25, wherein the particulate filler is an inorganic filler.

28. The method of claim 27, wherein the inorganic filler is at least one of clay, synthetic clay, calcium carbonate, magnesium carbonate, calcium hydroxide, calcium aluminate, magnesium carbonate, sand, gravel, crushed rock, bauxite, granite, limestone, sandstone, glass beads, aerogels, xerogels, mica, alumina, silica, fly ash, fumed silica, fused silica, tabular alumina, kaolin, microspheres, hollow glass spheres, porous ceramic spheres, gypsum dihydrate, insoluble salts, titanium dioxide, alumina white, aluminum sulfate, barium sulfate, gypsums, calcium sulfite, lithopone, pumice powder, zinc white, titanium oxide, talc, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, or a combination thereof.

29. The method of claim 25, wherein forming the mixture into a shape comprises applying the mixture to a mold or extruding the mixture.

30. The method of claim 25, wherein the article is a target.

31. The method of claim 30, wherein the target is a propellable target.
